(19) United States
(12) Patent Application Publication
(10) Pub. No.: US 2012/0222795 A1
(43) Pub. Date: Sep. 6, 2012

(54) TIRE WITH AIR BARRIER LAYER

(75) Inventors: Ramendra Nath Majumdar, Hudson, OH (US); William Paul Francik, Bath, OH (US)

(73) Assignee: The Goodyear Tire & Rubber Company

(21) Appl. No.: 13/469,133

(22) Filed: May 11, 2012

Related U.S. Application Data
(62) Division of application No. 12/408,067, filed on Mar. 20, 2009.
(60) Provisional application No. 61/054,931, filed on May 21, 2008.

(51) Int. Cl. B29D 30/00

(52) U.S. Cl. 156/73.1; 156/110.1

(57) ABSTRACT

The present invention relates to a pneumatic tire having an air barrier layer, particularly an integral pneumatic tire innerliner, for prevention, or retardation, of air permeation from its inner chamber to the atmosphere through the carcass of the tire. The innerliner is comprised of an annular, cylindrical, hoop of a film having its ends overlapped and heat sealed together. The film is comprised of a continuous thermoplastic polymer phase which contains a dispersion therein of cured rubber domains, particularly cured low unsaturation rubber domains. In one embodiment, one surface of the film contains a thin bonding layer to aid in bonding the film to an unsaturated rubber-containing tire carcass. In one embodiment, the overlapping portion of the ends of the film have a thin rubber layer positioned therebetween.

The Applicants hereby claim the benefit of prior U.S. Provisional Application Ser. No. 61/054,931, filed on May 21, 2008.

### FIELD OF THE INVENTION

The present invention relates to a pneumatic tire having an air barrier layer, particularly an integral pneumatic tire innerliner, for prevention, or retardation, of air permeation from its inner chamber to the atmosphere through the carcass of the tire. The innerliner is comprised of an annular, cylindrical, hoop of a film having its ends overlapped and heat sealed together. The film is comprised of a continuous thermoplastic polymer phase which contains a dispersion therein of cured rubber domains, particularly cured low unsaturation rubber domains. In one embodiment, one surface of the film contains a thin bonding layer to aid in bonding the film to an unsaturated rubber-containing tire carcass. In one embodiment, the overlapping portion of the ends of the film have a thin rubber layer positioned therebetween.

### BACKGROUND OF THE INVENTION

A pneumatic rubber tire is conventionally of a toroidal shape and comprised of a carcass with a cavity in which its closure is typically completed with a rigid rim onto which the tire is to be mounted. Such pneumatic tire and pneumatic tire/rim assemblies are well known.

The inner surface of a pneumatic tire, namely a surface of said cavity which is sometimes referred to as an “innerliner” is typically composed of an integral layer of an elastomeric composition intended to prevent, or retard, the permeation of air and moisture into the tire carcass from the aforesaid cavity. Such tire innerliner layers are well known to those having skill in such art.

Butyl rubber (including halobutyl rubber) has a relatively high air impermeability as well as a relatively high moisture impermeability and is often used as a major portion of the tire innerliner composition and can be in a form of butyl rubber or halobutyl rubber such as, for example, bromobutyl rubber. For example, see U.S. Pat. No. 3,808,177. Butyl rubber, while containing a minor amount of units derived from a diene such as, for example isoprene, is not considered herein as being a diene-based rubber since it contains less than 10 percent, and usually less than 5 percent, of its content derived form a diene monomer and, therefore, sulfur vulcanizes at a much slower rate than diene-based elastomers which contain at least, for example, 30 percent of their elastomer content derived from diene monomers. Such innerliner concept is well known to those skilled in such art.

In practice, the butyl rubber (e.g. halobutyl rubber) is simply applied to a tire building drum as a circumferential rubber layer to form a tire innerliner and the ends of the layer are simply joined by stitching (e.g. simply pressing) together their overlapping ends on the tire building drum using a suitable hand held roller. The remainder of the tire assembly, or components, are then built onto the building drum over the initially applied butyl rubber tire innerliner layer. Such process is well known to those having skill in such art.

Historically, tire innerliners for air permeability resistance have also been proposed which are comprised of a composite of a thermoplastic resin which contains a dispersed cured rubber. For example see U.S. Pat. Nos. 6,359,071, 6,376,598, 6,843,292, 6,861,470 and 6,538,066, Japanese patent publication No. JP 2006/315,339 and PCT WO 2006/121140.

For this invention, it is proposed to replace or supplement the aforesaid butyl rubber based tire innerliner layer with a film of such composite in a form of an annular hoop having its ends overlapped and heat sealed together.

The film for such purpose is comprised of a continuous thermoplastic polymer phase which contains a dispersion of cured rubber domains, particularly comprised of cured low unsaturation rubber domains.

In practice, one surface of the film composite may have a very thin non-tacky bonding layer thereon to aid in bonding the film to the rubber carcass of the tire since the film itself may have only a limited ability to adhere to the tire carcass rubber. By being non-tacky in nature, it is intended herein to mean that the bonding layer does not exhibit extensive building tack, particularly at room temperature (e.g. 23° C.). The bonding layer aids in adhering the film to the tire carcass rubber by heat activation of the bonding layer during the curing of the tire assembly itself at an elevated temperature. Such bonding layer may therefore be referred to in this description as being a “rubber-bonding” layer in a sense that it promotes bonding the film composite to the rubber or the tire carcass.

For the film composite, the low unsaturation rubber domains are comprised of a rubbery brominated copolymer of isobutylene and p-methylstyrene. By low unsaturation it is meant that the rubber contains a low, or essentially non-existent, carbon-to-carbon double bond content. Representative of such rubber is EXXPRO™ from ExxonMobil.

The rubber domains are provided as a curative-containing elastomer (e.g. curative-containing brominated copolymer of isobutylene and p-methylstyrene. Such rubber is then blended with the thermoplastic polymer in a high shear mixing operation to form a thermoplastic elastomer composition in a form of a continuous phase thermoplastic polymer matrix which contains a discontinuous elastomer (rubber) dispersion therein.

The rubber domains become cured within the thermoplastic polymer matrix during a high shear mixing thereof at an elevated temperature sufficient to at least partially cure the rubber domains with a suitable curative contained in the rubber itself such as, for example, sulfur-containing curative. Sometimes, such composite might be referred to as being dynamically cured in a sense being a dynamically vulcanized alloy in which the dispersed rubber domains become at least partially cured (vulcanized) within the thermoplastic polymer matrix.

The continuous thermoplastic polymer phase of the thermoplastic elastomer composite contemplated for use in this invention is comprised of at least one of Nylon 6, Nylon 66, Nylon 6/66, Nylon 610 and Nylon 11, preferably Nylon 6/66, Nylon 6 or Nylon 66.

In practice, Nylon 6 may be envisioned as being a polycaprolactam.

In practice, Nylon 66 may be envisioned as being poly(hexamethylene adipamide) as a copolymer of hexamethylene diamine and adipic acid.

In practice, Nylon 6/66 may be envisioned as being a terpolymer of hexamethylene diamine, adipic acid and caprolactam.

It is preferred that such thermoplastic polyamides have a softening point in a range of from about 170° C. to about 220° C.

Representative of such film composite, which might sometimes be referred to as being a “DVA” film, is, for example, composed of a nylon 6/66 continuous thermoplastic polymer phase which contains a dispersion of cured rubber domains comprised of brominated copolymer of isobutylene and p-methylstyrene. Such film composition might, for example, be referred to as a dynamically vulcanized alloy obtainable from ExxonMobil. For further description thereof, see the aforesaid patent publications.

In practice, the DVA film may, for example, be a DVA film composite in a form of a pre-formed unitary continuous hoop (unitary and continuous in a sense of not having a seam of overlapped ends) which is positioned onto a tire building drum. If the film has a thin bonding layer on one of its surfaces, the bonding layer would be on a surface of the film which faces away from the building drum (not touching the building drum). The remainder of the tire assembly, or components, are then built over the initially applied pre-formed unitary, seamless DVA film hoop on the building drum. Such method of tire making is described, for example, by D. S. Tracey and A. H. Tson in Rubber World magazine, September 2007 on Page 17.

In practice, the seamless DVA film hoop may be manufactured, for example, by well known film blowing methods to form a seamless cylindrical tube of the thermoplastic elastomer composite. Cross-sections of the cylindrical tube are cut to form seamless cylindrical hoops of the film having the diameter of the cylindrical tube from which they are cut.

A significant disadvantage can readily be seen in the sense that it becomes necessary to maintain a special inventory of such cylindrical hoops of various diameters to accommodate a variety of tire sizes, particularly since it is often desired for the film hoop to fit the inner surface of an uncured tire to which the film hoop is applied rather exactly to accommodate the tire building process. It is considered that ill fitting hoops would have to be scrapped.

In practice, it might be thought of to simply apply a sheet of the thermoplastic elastomer film to onto a building drum with the film ends overlapping each and proceed to build the remainder of the tire components in a manner similar to application of a sheet of a tacky (building tack surfaced) rubber innerliner layer for building the tire.

In such existing practice, care is to be taken not to pre-heat overlapped portion of the tacky (building tack surfaced) sheet of rubber inner liner layer because it would then have an unwanted heat history and pre-cure variation, prior to vulcanization of the tire at an elevated temperature.

Application of the thermoplastic elastomer DVA film to the tire building drum at room temperature, in a fashion similar to the aforesaid application of a rubber inner liner layer instead of the DVA film, whether or not the DVA film contains a rubber bonding layer thereon, is not envisioned as being a logical or suitable option because of, for example, the difficulty in adhering, or securing, the film, with its lack of building tack, to the uncured rubber tire components.

It is also considered herein would not be logical, in view of the aforesaid more normal rubber tire innerliner application in a tire building process, to apply the thermoplastic elastomer (DVA film) with an initial heat history to the uncured rubber components.

Accordingly, this invention is considered herein to be a significant discovery in light of such past practice.

In practice, the DVA film itself typically has little surface building tack (tacky surface to promote lightly adhering to an uncured rubber surface which might be referred to as rubber-building tack) so it is not seen herein that a flat film of DVA (film not in a continuous hoop form) could readily be formed into individual hoops of various desired diameters by simply forming designed hoops (hoop of designed, pre-determined or fitted hoop diameter) of the film with ends overlapping at room temperature and relying on (non-existing) surface building tack to hold the film together without application of an adhesive (e.g. pressure sensitive adhesive) to a surface of the film.

For this invention, for a tire building process, it has been discovered that the overlapping ends of a DVA sheet can be adhered together in an overlapped configuration to form an annular hoop thereof by heat sealing its overlapping ends together to form a seam-containing hoop. While the idea, once conceived, seems relatively simple nature, it goes against conventional wisdom in the tire manufacturing process because, in one aspect, it adds a “thought to be unwanted” pre-heat history to tire building process prior to the vulcanization of the tire. In such manner, then, it has been discovered that a DVA annular hoop can be formed of a desired diameter and applied as a tire innerliner layer as a part of a tire building process.

While the heat sealing process may not be completely understood, it is envisioned that the overlapped ends of the DVA film become heat sealed together to form a durable seam by a possible interfacial co-curing of discontinuous cured rubber domains (which contain a curative which may not be completely reacted in the DVA film formation) on the surface of one film surface against such domains on the other overlapped surface of the film and/or a degree of coalescing of the continuous thermoplastic phase at the interface between the overlapped ends of the DVA film.

As discussed, in tire manufacturing processes, various uncured rubber components for the tire are conventionally spliced together without a heating step being applied to the splice (therefore eliminating such heat history to the tire innerliner) because of concerns that a premature vulcanization may occur.

As discussed, in order to facilitate such splicing, the uncured rubber components are provided with a tacky surface (namely, building tack for adhering to an uncured rubber surface) and are joined at their splice by simply stitching (applying pressure at the splice) with a roller, a method well known by those having skill in such art without adding heat history to the splice.

It is to be therefore emphasized that it is considered that heat sealing overlapping ends of DVA film together to form a seam-containing hoop for a tire innerliner component of a tire before its vulcanization at an elevated temperature is novel and of a significant discovery.

In the description of this invention, the term “phr” where used herein, and according to conventional practice, refers to “parts of a respective material per 100 parts by weight of rubber, or elastomer”. The terms “rubber” and “elastomer” where used herein, may be used interchangeably, unless otherwise prescribed.

### SUMMARY AND PRACTICE OF THE INVENTION

In accordance with this invention, a pneumatic tire is provided which contains an innerliner film layer;

wherein said film layer is comprised of a dynamically vulcanized alloy comprised of a thermoplastic continuous phase containing a dispersion of discontinuous cured rubber domains;

characterized in that said innerliner film layer is comprised of a seamed hoop of said film wherein said seam is comprised of heat sealed overlapped ends of said film.

In practice, said innerliner film layer is desirably positioned in a form of a seamed hoop (thereby in a centrifugal configuration in the tire) with its opposite ends meeting in an overlapped condition to form said seam.

In practice, the dynamically vulcanized alloy is prepared by, and is the product of, blending a thermoplastic polymer (or polymers) under a high shear condition at an elevated temperature sufficient to at least partially cure a dispersion of an elastomer within said thermoplastic polymer;

wherein said thermoplastic polymer is the continuous phase and said cured elastomer particles constitute a dispersed phase;

wherein said elastomer is, for example, comprised of a halogenated (e.g. brominated) copolymer of isobutylene and p-methylstyrene;

wherein said thermoplastic polymer is comprised of, for example, a polyamide comprised of at least one of Nylon 6, Nylon 66 and Nylon 6/66 wherein said polyamide preferably has a softening point in a range of from about 170° C. to about 220° C.

Accordingly, said film-based hoop for this invention contains a seam comprised of said heat sealed overlapped ends of said film.

Said heat sealing of said overlapped portion of said film may be accomplished by various means such as, for example, by application of heat (elevated temperature) which can be accomplished by, for example, hot press (e.g. under pressure with the film positioned between platens), hot air blower (e.g. heated air gun directed to the overlapped portion of the film), ultrasonic welding (applied to the overlapped portion of the film), laser beam or microwave heating.

Such heat sealing of the overlapped film portion to form a seam-containing hoop may be accomplished, for example, prior to application of the hoop to a tire building process (e.g. prior to fitting the hoop onto a tire building drum or prior to application of the hoop to an inner surface of a tire rubber carcass) or, alternatively, subsequent to application of the film to a tire building drum (so the film may be fitted, or sized, directly to the tire building drum).

In an embodiment of the invention, building a tire (pneumatic tire) which comprises providing a film layer on a tire building drum in a form of a hoop thereof with an overlapping end portion comprised of overlapping ends thereof heat sealed together to form a seam followed by building tire rubber components onto the building drum over said film layer to form an assembly thereof and vulcanizing the assembly in a suitable mold at an elevated temperature to form a pneumatic tire;

wherein said film layer is comprised of a dynamically vulcanized alloy comprised of a thermoplastic elastomer continuous phase containing a dispersion of discontinuous cured rubber domains;

wherein said dynamically vulcanized alloy is the product of blending of at least one thermoplastic polymer under a high shear condition at an elevated temperature sufficient to at least partially cure a dispersion of elastomer particles within said thermoplastic polymer;

wherein said thermoplastic polymer is the continuous phase and said cured elastomer particles constitute a dispersed phase;

wherein said elastomer is comprised of a brominated copolymer of isobutylene and p-methylstyrene;

wherein said thermoplastic polymer is comprised of at least one polyamide comprised of Nylon 6, Nylon 66 and Nylon 6/66.

In one embodiment, said heat sealing of said overlapped portion of said film is by a means comprised of application of heat, which can be accomplished by, for example, hot press or hot air blower or ultrasonic welding or laser beam or by microwave heating.

In one embodiment, said process comprises applying a butyl rubber (e.g. bromobutyl rubber) based tire innerliner layer onto a tire building drum, applying said film hoop with its overlapping ends heat sealed together to form a seam onto said butyl rubber based tire innerliner layer, followed by building tire components onto the building drum over said film layer to form an assembly thereof and vulcanizing the assembly in a suitable mold at an elevated temperature to form a pneumatic tire.

In one embodiment said process comprises applying said film layer onto a tire building drum to form a hoop thereof and heat sealing its overlapping ends together to form a seam followed by building tire rubber components onto the building drum over said film layer to form an assembly thereof and vulcanizing the assembly in a suitable mold at an elevated temperature of form a pneumatic tire.

In one embodiment, said process comprises forming a hoop of said film with an overlapping end portion, heat sealing said overlapping end portion to form a seam and applying said hoop onto a tire building drum followed by building tire rubber components onto the building drum over said film layer to form an assembly thereof and vulcanizing the assembly in a suitable mold at an elevated temperature to form a pneumatic tire.

In one embodiment, said process is provided wherein the overlapping portion of said film contains a rubber layer therebetween.

In another embodiment of the invention, said film layer contains a rubber-bonding layer (bonding layer for bonding the film to an unsaturated elastomer based rubber composition such as a tire carcass ply component to be built over the film layer) on one of its surfaces wherein, for said overlapping portion of said film, one film surface is positioned against said bonding layer surface of said film.

In said process of building said tire, the surface of said film layer which contains said bonding layer faces away from and thereby does not touch the building drum.

In practice, said dynamically vulcanized thermoplastic elastomer tire innerliner layer may have a thickness ranging from about 0.025 mm to about 1 mm depending somewhat upon the nature of the pneumatic tire and its intended use.

If desired, said thermoplastic polymer may contain a plasticizer to aid in its processing such as, for example, N-butylbenzene sulfonamide.

A significant aspect of the invention is the heat sealing of the overlapping ends of the film together to form a seam-containing hoop thereof which is considered herein to be a significant departure from past practice of utilization of pre-formed seamless hoops of the film for the preparation of a tire innerliner.

### BRIEF DESCRIPTION OF THE DRAWINGS

Drawings are provided to present a further understanding of the invention. For the Drawings, FIGS. 1 through 4 (FIG. 1, FIG. 2A, FIG. 2B, FIG. 3, and FIG. 4) are provided.

FIG. 1, FIG. 2A and FIG. 2B depict two DVA film strips with their ends overlapped and heat sealed together.

FIG. 3 depicts an application of a DVA film to a tire building drum to form a hoop thereof of DVA film with its overlapping ends heat sealed together.

FIG. 4 depicts a section of a tire with a hoop of DVA film on its inner surface with its overlapping ends heat sealed together.

### THE DRAWINGS

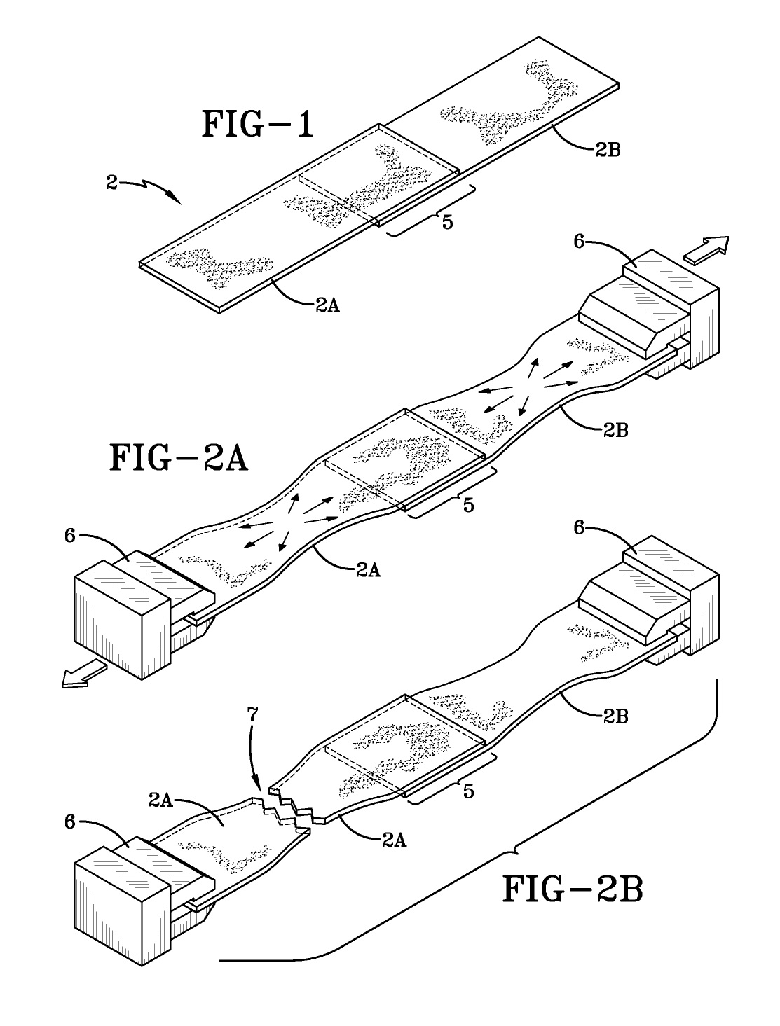

In FIG. 1, a composite (2) is shown comprised of two rectangular strips (2A) and (2B) of DVA film having their ends overlapped to form an overlapped portion (5).

The DVA film is comprised of a discontinuous at least partially cured elastomer phase (thereby containing a residual curative content in the discontinuous phase rubber) and a continuous thermoplastic phase.

The DVA film strips (2A) and (2B) are heat sealed together to form the composite (2) thereof in their overlapped portion (5) by application of heat (elevated temperature) to cause the two phases to coalesce together and/or cause the said cured discontinuous phases of the film to co-cure together at the interface of the contacting film surfaces) and unlike conventional sulfur vulcanization, did not affect the subsequent adhesion to rubber compounds as shown by the building of the tire and subsequent testing of the tire.

The discontinuous elastomer phase for this drawing is envisioned as being comprised of cured brominated copolymer of isobutylene and p-methylstyrene, said copolymer as EXXPRO™ from ExxonMobil.

The continuous polymer phase for this drawing is envisioned as being comprised of nylon 6/66.

Each of the DVA films strips (2A) and (2B) individually have dimensions of about 1 inch (about 2.54 cm) by about 3 inches (about 7.6 cm) are joined by having their ends overlapped to form the overlapped portion (5) having a dimension of about 1 inch (about 2.54 cm) in length. In FIG. 2, the composite (2) of the heat sealed DVA strips (2A) and (2B) are submitted to attempt to pull them apart using an Instron™ test instrument to evaluate the strength of the bond of the heat sealed DVA strips in the overlapped portion (5).

In FIG. 2 it seen that the composite (2) is stretched to the extent that the individual DVA strips are lengthened and narrowed. In FIG. 2B it is seen that the composite (2) broke at position (7) which is outside the overlapped portion (5) which therefore demonstrates that heat sealing of the overlapped DVA strips (2A) and (2B) together created a bond which is stronger than the individual DVA strips (2A) and (2B) and, further, is satisfactory for a purpose of building the tire. Subsequently, for a prepared tire, the overlapped portion of the DVA film survived without breaking. One side of the DVA film was coated with a thin coat of a bonding agent for bonding the film to an unsaturated rubber-containing tire carcass ply. Results were consistent whether the bonding agent coated side of the DVA film overlapped the film side of the DVA film or the film sides (without the presence of the bonding agent coating) of the DVA film overlapped each other.

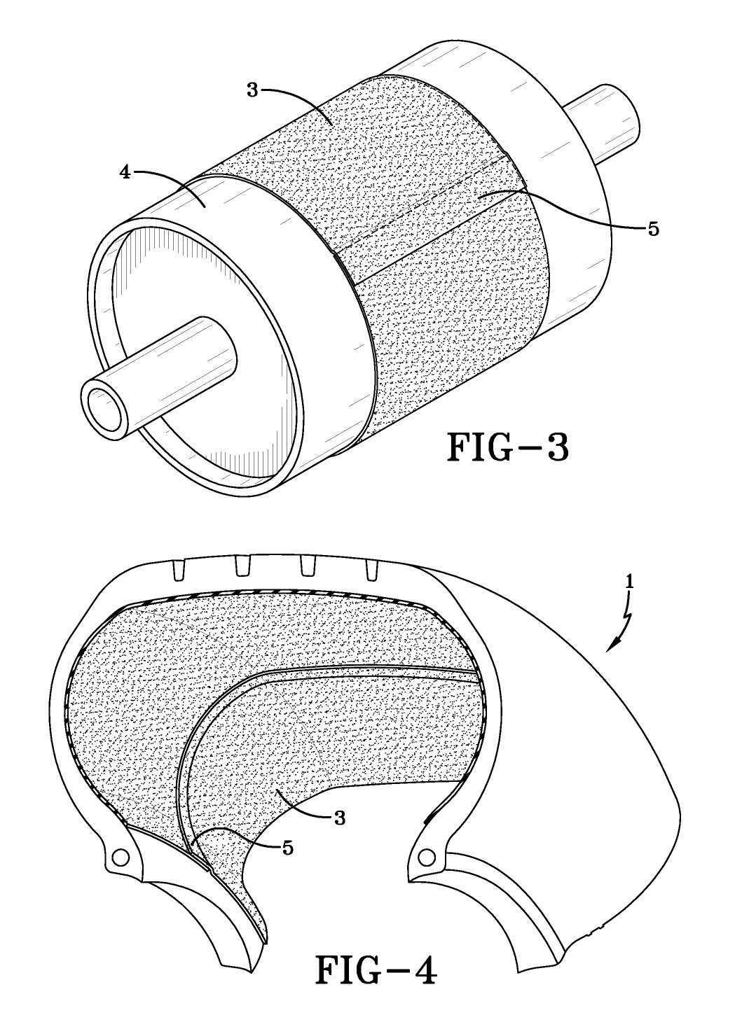

In FIG. 3, a tire building drum (4) is shown with a hoop of a DVA film (3) having been applied with its ends being overlapped to form an overlapped portion (5). Heat is applied to the overlapped portion (5) by an industrial grade heated air blower to heat seal the overlapped portion (5) by causing the DVA film to coalesce and thereby heat seal to itself to form a seam.

The following example is provided for a further understanding of the invention and is not intended to be limiting.

### EXAMPLE I

### Evaluation of Heat Sealing

A sheet of film composed of a continuous thermoplastic Nylon matrix (e.g. Nylon 6/66) having a softening point within 170° C. to 220° C., which contained a dispersion of at least partially cured rubber particle domains (comprised of cured brominated copolymer of isobutylene and p-methylstyrene and curative for said copolymer), (the film composite is referred to herein as a dynamically vulcanized alloy, or “DVA”) was cut into rectangular strips to evaluate whether their ends may be suitably overlapped and heat sealed together to form a pneumatic tire innerliner in a shape of an annular hoop in a similar manner depicted in FIG. 2 herein.

Such evaluation was deemed appropriate since the DVA film surface did not have sufficient building tack for joining its overlapping ends together and that suitable surface building tack is considered herein as being essential for joining the overlapping ends of the DVA film together prior to heat sealing the overlapping film ends together.

For this example, the rectangular DVA film strips had a length of about 3 inches (about 7.6 cm) and a width of about 1 inch (about 2.5 cm).

An end of one rectangular DVA strip was positioned over the end of another of the rectangular DVA strip in an overlapping configuration in a manner similar to FIG. 1 herein to form a composite thereof with a created overlapped portion, or segment, of the two DVA strips being about 1 inch (about 2.5 cm) long.

The overlapped portion of the DVA film was placed in a hot press (under applied pressure between platens of a hot press) and the overlapping film portions pressed together at a temperature of about 180° C. to cause the overlapped portion of the film to coalesce and/or co-cure together at their interface and become heat sealed together (form a seam of the heat sealed composite).

The composite was pulled at room temperature (e.g. about 23° C.) by the Instron instrument at a crosshead speed of 508 mm/min in a manner depicted in FIG. 2A. The composite elongated and eventually broke in a manner depicted in FIG. 2B at an elongation of about 397 percent.

Accordingly, it is concluded herein that the overlapped ends of the DVA sample film were successfully heat sealed together in what is referred to herein as a splice, and, further, that such heat sealed splice would therefore be suitable for use as a component (tire innerliner) of a tire assembly without adding additional heat history to the tire assembly itself prior to vulcanization of the tire assembly.

The above experiment was repeated using an ultrasonic welder to heat seal the overlapped portion of the film together (by ultrasonic welding) and similar results were obtained.

The above experiment was repeated where an uncured thin sheet of rubber was applied between the overlapped portion of the samples and similar results were obtained.

### EXAMPLE II

A film (sheet form of the film) of DVA was wrapped around a tire building drum with its ends overlapped to form a composite hoop thereof in a manner depicted in FIG. 3. The overlapped portion of the ends were heat sealed together on the tire building drum, using an industrial grade hot air gun (hot air blower), so that the film fitted in a form of a seam-containing hoop onto the tire building drum.

The remainder of the tire was assembled and built on the building drum with the prepared, seam-containing, fitted DVA hoop becoming the tire innerliner.

The resulting assembly was placed in a suitable mold and cured at an elevated temperature of about 175° C. to from a cured rubber tire with the heat sealed DVA film as its innerliner, of which a section of the tire is shown in FIG. 4.

The resultant tire was successfully tested to evaluate the suitability of the pre-formed film hoop, including the stability of the heat sealed overlapped film seam of the overlapped film portions.

While certain representative embodiments and details have been shown for the purpose of illustrating the invention, it will be apparent to those skilled in this art that various changes and modifications may be made therein without departing from the spirit or scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A process of building a tire which comprises providing a film layer on a tire building drum in a form of a hoop thereof with an overlapping end portion comprised of overlapping ends thereof heat sealed together to form a seam followed by building tire rubber components onto the building drum over said film layer to form an assembly thereof and vulcanizing the assembly in a suitable mold at an elevated temperature of form a pneumatic tire;
wherein said film layer is comprised of a dynamically vulcanized alloy comprised of a thermoplastic elastomer continuous phase containing a dispersion of discontinuous cured rubber domains;
wherein said dynamically vulcanized alloy is the product of blending of at least one thermoplastic polymer under a high shear condition at an elevated temperature sufficient to at least partially cure a dispersion of an elastomer particles within said thermoplastic polymer;
wherein said thermoplastic polymer is the continuous phase and said cured elastomer particles constitute a dispersed phase;
wherein said elastomer is comprised of a brominated copolymer of isobutylene and p-methylstyrene;
wherein said thermoplastic polymer is comprised of at least one polyamide comprised of Nylon 6, Nylon 66 and Nylon 6/66.

16. The process of claim 15 wherein said heat sealing of said overlapped portion of said film is by a means comprised of application of heat by hot press, by hot air blower, by ultrasonic welding, by laser beam or by microwave heating.

17. The process of claim 15 wherein said hoop of said film is provided by applying a butyl rubber based tire innerliner layer onto a tire building drum, applying said film hoop with its overlapping ends heat sealed together to form a seam onto said butyl rubber based tire innerliner layer, followed by building tire components onto the building drum over said film layer to form an assembly thereof and vulcanizing the assembly in a suitable mold at an elevated temperature of form a pneumatic tire.

18. The process of claim 15 which comprises applying said film layer onto a tire building drum to form a hoop thereof and heat sealing its overlapping ends together to form a seam followed by building tire rubber components onto the building drum over said film layer to form an assembly thereof and vulcanizing the assembly in a suitable mold at an elevated temperature of form a pneumatic tire.

19. The process of claim 15 which comprises forming a hoop of said film with an overlapping end portion, heat sealing said overlapping end portion to form a seam and applying said hoop onto a tire building drum followed by building tire rubber components onto the building drum over said film layer to form an assembly thereof and vulcanizing the assembly in a suitable mold at an elevated temperature of form a pneumatic tire.

20. The process of claim 15 wherein the overlapping portion of said film contains a rubber layer therebetween.
